(19) United States
(12) Patent Application Publication
(10) Pub. No.: US 2024/0037658 A1
(43) Pub. Date: Feb. 1, 2024

(54) ALGORITHMIC ORDER AUTONOMY

(71) Applicant: Modulus Global, Inc., Scottsdale, AZ (US)

(72) Inventors: John Jozwiak, Cave Creek, AZ (US); Richard Gardner, Scottsdale, AZ (US)

(21) Appl. No.: 18/359,463

(22) Filed: Jul. 26, 2023

Related U.S. Application Data
(60) Provisional application No. 63/392,449, filed on Jul. 26, 2022.

(51) Int. Cl. G06Q 40/04; G06F 9/451

(52) U.S. Cl. CPC G06Q 40/04; G06F 9/451

(57) ABSTRACT

Methods, systems, and computer programs are described for executing an autonomous trade order at a digital exchange. Uncompiled computer code is received at an exchange engine at the digital exchange. The uncompiled computer code defines the autonomous trade order. The uncompiled computer code is compiled and executed by the exchange engine. The executing includes instantiating an instance of the autonomous trade order and filling the autonomous trade order based on a determination that one or more conditions specified in one or more trading instructions included in the autonomous order have been satisfied. The determination is based on a detection that one or more events referenced from the pre-programmed trading instructions have occurred at the electronic digital exchange or an identification that one or more values of one or more variables referenced from the trading instructions have transgressed one or more values of one or more thresholds.

### CROSS-REFERENCE TO RELATED APPLICATIONS

This application claims the benefit of U.S. Provisional Application No. 63/392,449, filed Jul. 26, 2022, which is incorporated by reference herein in its entirety.

### TECHNICAL FIELD

The subject matter disclosed herein generally relates to methods, systems, and machine-readable storage media for techniques for implementing a digital exchange and, in one specific example, to techniques for implementing a digital exchange that supports autonomous orders.

### BACKGROUND

To support trading of an asset (e.g., a stock, currency, future, or other financial instrument), digital exchanges provide traders with the ability to place orders to buy and/or sell the asset.

Each order associated with an asset can be one of several basic order types, such as a market order (MKT) (specified to buy or sell the asset at the current ask price or bid price), a limit order (LMT) (specified to buy or sell the asset at a specific price or better, or a stop order (STP) (specified to buy or sell the asset at the best available price).

These three basic order types can be combined to create more complex order types, including a stop order (STP) (specified to buy or sell the asset at the best available price, but only if the market reaches a specific price), a stop-limit order (specified to combine a stop order and a limit order to ensure a specific price for the asset), a trailing stop order (specified to set a specific market price for triggering of a creation of a stop order or a stop-limit order for the asset), or a market-if-touched (MIT) order (specified to set a market price for triggering of creation of a market order for the asset), or a limit-if-touched order (LIT) (specified to set both a trigger price and a limit price for the asset).

In general, a market order may be used to enter or exit a position quickly, but gives the least control over price. A limit order guarantees a specified maximum price for purchases or a specified minimum price for sells, but won't execute as quickly (or perhaps won't execute at all).

The digital exchange may maintain an order book for an asset based on orders it receives that correspond to the asset. The order book may be an electronic list of buy and sell orders for the asset. On the sell side, the order book may be listed in ascending order with the lowest ask price appearing first. On the buy side, the order book may be listed in descending order, with the highest bid listed first.

### BRIEF DESCRIPTION OF THE DRAWINGS

The appended drawings merely illustrate example embodiments of the present disclosure and cannot be considered to be limiting its scope.

FIG. 1 is a block diagram depicting an example system according to some embodiments.

FIG. 2 is a block diagram depicting an example exchange engine of FIG. 1.

FIG. 3 is a flowchart of an example method for implementing autonomous orders at a digital exchange.

FIG. 4 is a block diagram depicting system interactions with respect to an extendable order wizard.

FIG. 5 is a flowchart of an example method for executing an autonomous order at the digital exchange.

FIG. 6 shows an example of uncompiled code that is to be submitted to the exchange engine for compiling, linking, and executing.

FIG. 7 is a screen shot of an example graphical user interface (GUI) (e.g., for presentation on a client or broker machine).

FIG. 8 is a block diagram depicting an example mobile device, according to an example embodiment.

FIG. 9 is a block diagram depicting a machine in the example form of a computer system within which instructions for causing the machine to perform any one or more of the methodologies discussed herein may be executed.

### DETAILED DESCRIPTION

The description that follows describes systems, methods, techniques, instruction sequences, and computing machine program products that constitute illustrative embodiments of the disclosure, individually or in combination. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details.

Methods, systems, and computer programs are described for implementing algorithmic trading and/or algorithmic order autonomy at a digital exchange. Uncompiled or pre-compiled computer code defining one or more autonomous orders is submitted by one or more machines (e.g., one or more client machines and/or one or more broker machines) and received at the digital exchange. The computer code is compiled (e.g., if uncompiled), linked (e.g., to functions made accessible at the digital exchange to the one or more autonomous orders), and executed within a computer environment managed by the digital exchange (e.g., at an exchange engine executing at the digital exchange). The autonomous orders are placed into an order book at the digital exchange and fulfilled at the digital exchange if and when conditions specified by the autonomous orders are met—all without any human intervention being needed.

Each autonomous order may be self-managing and may spawn one or more child autonomous orders that are themselves self-managing within the digital exchange. The autonomous order may directly call one or more APIs or local functions available within the environment or APIs or functions that are made accessible to the autonomous order from outside the environment, such as APIs or functions provided at a broker system. In example embodiments, broker systems may submit autonomous orders for execution at the digital exchange that include one or more functions that may be packaged by the digital exchange and accessed dynamically by one or more other autonomous orders executing at the digital exchange. The autonomous orders may be configured to evolve within the environment (e.g., based on application of one or more algorithms described herein, including one or more genetic algorithms).

A genetic algorithm may determine a “fittest” version of an autonomous order. The implementation of the genetic algorithm may be defined by the autonomous order itself or by one or more modules of the exchange engine. The genetic algorithm may cause one or more other autonomous orders to be spawned from an autonomous order, each with different characteristics (e.g., using different values for one or more variables upon which execution of the autonomous order is based). After each generation or cycle, different characteristics of “offspring” of an autonomous order may be used (e.g., combined) in the next generation or cycle. The sequence may be repeated with a goal of producing individuals in each new generation that are better than in the previous generation (e.g., with respect to one or more goals or metrics, such as one or more goals or metrics defined by the autonomous order), as described in more detail below.

For example, a goal defined in the uncompiled or pre-compiled computer code for an autonomous order may be to ensure that the autonomous order is to be fulfilled by the algorithmic trading exchange with the lowest possible latency. The autonomous code within the exchange engine may evolve (e.g, through application of one or more genetic algorithms) to further reduce latency in each successive generation of the autonomous order (e.g, until a lowest possible latency for execution of the autonomous order is achieved).

The autonomous order may be configured to report its status (e.g., to one or more client machines), including values of its parameters or variables, its state of evolution (e.g., information pertaining to any new computer code that it has generated or children it has spawned), its interactions with other autonomous orders, and so on. In example embodiments, the autonomous orders or the exchange engine may communicate updates pertaining to execution of the autonomous orders to one or more client devices in real-time, thus enabling actions to be taken at the one or more client devices to remotely control the autonomous orders during their execution at the digital exchange.

In example embodiments, code executing on the client device may be configured to instruct the exchange engine to stop or pause certain autonomous orders, delete certain autonomous orders under certain conditions, and/or block certain pathways of evolution (e.g., as determined by a genetic or other machine-learning algorithm) for certain autonomous orders (e.g., based on one or more remote processing rules, such as one or more remote processing rules defined on a broker or client machine). In example embodiments, a user interface may be provided at the client device for submitting code for one or more autonomous orders, viewing execution of instances of the one or more autonomous orders in real time, and taking one or more actions to intervene in or control the execution of the one or more autonomous orders.

Because the computer code for each autonomous order is compiled (e.g., if uncompiled), linked, and executed within the exchange engine at the digital server, not only is latency in trading reduced in comparison to execution of such code outside of the digital exchange, but also, custom or exotic order types can be implemented that go beyond that of the basic order types. Custom or exotic order types may include order types that are implemented conditionally based on information available at the digital exchange in real time, including data pertaining to other autonomous orders submitted for execution at the digital exchange and configured to be added to an order book maintained by the digital exchange. Additionally, because the code is compiled and/or vetted at the digital exchange, the chances that nefarious or misbehaving code is ever executed at the digital exchange is reduced or entirely eliminated, resulting in a secure trading environment.

In example embodiments, order types are generalized by considering orders as instantiated running functions, which execute within an exchange engine and take parameters particular to their individual order identities upon instantiation. In this way, basic order types may be trivially realized, and new order types may be invented by traders and/or value-adding brokers.

In example embodiments, uncompiled or pre-compiled computer code is received via an API at an exchange engine at an electronic digital exchange. The uncompiled or pre-compiled computer code defines an autonomous trade order. The autonomous trade order includes one or more pre-programmed trading instructions. The uncompiled or pre-compiled computer code is compiled (e.g., if it is uncompiled) and executed by the exchange engine. The executing includes instantiating the autonomous trade order and filling the autonomous trade order based on a determination that one or more conditions specified in the one or more pre-programmed trading instructions have been satisfied. The determination is based on a detection that one or more events referenced from the pre-programmed trading instructions have occurred at the electronic digital exchange and/or an identification that one or more values of one or more variables referenced from the pre-programmed trading instructions have transgressed one or more values of one or more thresholds at the electronic digital exchange.

In example embodiments, execution of autonomous trade orders may depend, at least in part, on values of functions that are computed while the autonomous order resides with and/or observes the digital exchange, rather than depending entirely on static values, as described in more detail herein.

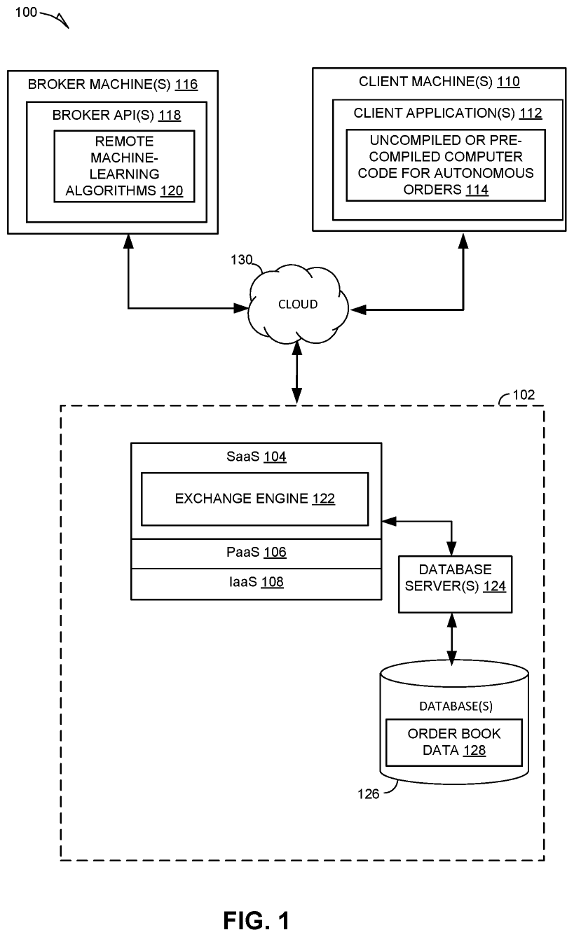

FIG. 1 is a block diagram depicting an example system 100 (e.g., a digital exchange system) according to some embodiments. As shown, system 100 includes broker machines 116, client machines 110, and electronic digital exchange 102 that is connected to a communication network, such as cloud 130.

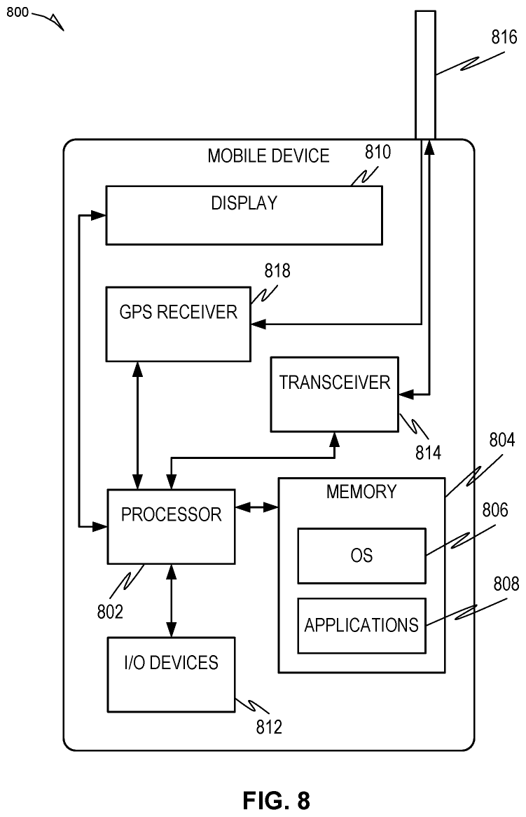

Broker machine(s) 116 or client machines 110 may comprise one or more computing devices that are connected to the electronic digital exchange 102, including an exchange engine 122 executing in the digital exchange. A computing device may be any type of general computing device capable of network communication with other computing devices. For example, a computing device can be a personal computing device such as a desktop or workstation, a business server, or a portable computing device, such as a laptop, a smartphone, or a tablet personal computer (PC). A computing device can include some or all of the features, components, and peripherals of the machine 800 shown in FIG. 8. The one or more computing devices are specially configured (e.g., via instructions 924 or applications 808) to perform one or more of the operations or methodologies described herein; in fact, without such special configuration, the one or more computing devices would be unable to perform various described operations or methodologies.

The client machines 110 can include client application(s) 112, which allow the client to interact with electronic digital exchange 102. For example, the client application(s) 112 may facilitate submission of uncompiled or pre-compiled computer code for autonomous orders 114 to the digital exchange and/or receiving of notifications from the digital exchange, including notifications that include information pertaining to autonomous orders that have been submitted to the digital exchange.

Such information may include state information (e.g., including a code execution state, such as whether the code has been received, is being compiled, is being linked, is being vetted, is executing, or is paused (e.g., within a computer environment maintained by an exchange engine at the digital exchange); a state of one or more trading instructions that the autonomous order has caused to be placed in (or removed from) an order book of the digital exchange (e.g., including values of variables upon which execution of the one or more trading instructions is based); debugging data (e.g., values of variables at run-time or at one or specified times in the past and/or return values received from functions invoked by the autonomous orders, including local functions accessible within the computer environment of the digital exchange and remote functions accessible on servers external to the digital exchange); information pertaining to family members of the autonomous order (e.g., pointers to autonomous orders that are parents, siblings, or children of the autonomous order); information about communications between autonomous orders (e.g., a history of communications sent to other autonomous orders or received from other autonomous orders); information pertaining to any trades of one or more assets that are caused to be executed and fulfilled by the autonomous order, and so on.

The information received from the digital exchange may be responded to by one or more applications executing on a client device (e.g., to implement external rules associated with implementation of the autonomous order) and/or may be be presented dynamically within a user interface on the client device in real-time such that user of the client device may view updates with respect to submitted autonomous orders and/or take action with respect to each submitted autonomous order, such as starting or stopping the autonomous order, debugging the autonomous order, and/or changing the code associated with the autonomous order (e.g., including values of parameters), and so on.

In some embodiments, the broker machines 116 and/or client machine(s) 110 may interact with the electronic digital exchange through broker API(s) 118 or client APIs, respectively, which may be configured to process data received from exchange engine 122, including applying output from one or more machine learning algorithms 120 or implementing one or more remote rules pertaining to execution of one or more autonomous orders. In example embodiments, autonomous orders may be configured to query APIs associated with the broker machines 116 if desired custom functionality, such as application of particular machine learning algorithms 120, is not detected within the local computer environment of the digital exchange.

Strategies leveraging functions accessible locally within the computer environment of the digital exchange, including local machine learning algorithms, or functions accessible via APIs on the broker machines 116 and/or client machines 110, including remote machine-learning algorithms) may be used to optimize an autonomous order with respect to any metric, such as speed of execution of the autonomous order, prices associated with buying or selling of an asset at the digital exchange, timing of buying or selling of an asset, and so on, based on any information that is available to the autonomous order as it is executing in real-time at the digital exchange. For example, the autonomous order may call one or more local machine-learning functions to determine an optimal time for an order based on volume of orders associated with an asset, likelihood of fulfillment of the trade order within a particular time frame, and so on. The machine learning algorithms may rely on neural networks, k-means functions, or any other techniques to determine data related to timing, the volume of the order, expiration dates on orders, trends, prices, etc.

The machine-learning algorithms may be trained in real-time on the digital exchange with data accessible to the digital exchange in real-time and/or using infrastructure, platform, and software services accessible and allocated in dynamic amounts at the digital exchange, thus allowing for training and/or application of local machine-learned models more accurately, more efficiently, and/or more quickly than training and application of such models remotely (e.g., at a remote machine). In example embodiments, the autonomous orders themselves may define one or more machine-learning models, including inputs, outputs, and training parameters that are to be implemented at the digital exchange in real time. In example embodiments, local machine-learned models, including those defined by autonomous orders, may be trained in real-time at the digital exchange using data that is accessible at the digital exchange (e.g., via one or more local functions of the digital exchange). The locally trained models may then be applied by an autonomous order (e.g., as soon as a specified training procedure has been completed) to modify variables of the autonomous order that determine if and when the autonomous order is to added to the order book and fulfilled by the digital exchange.

In example embodiments, an autonomous order may request or be assigned a level of priority of execution with respect to other autonomous orders managed by the digital exchange and/or the autonomous order may request one or more system resources (e.g., infrastructure, platform, or software services, including hardware services) that are to be used to execute the autonomous order. Thus, for example, an autonomous order may request reservation of computing resources, such as processors or memory, in order to guarantee execution of one or more trading orders defined by the autonomous order within a particular amount of time (e.g., if and when the conditions specified by the autonomous order are met). Thus, for example, complex trading instructions that are dependent on values of many variables and/or require application of one or more machine-learning algorithms may guarantee that they will be processed by the exchange engine within minimum performance thresholds.

In example embodiments, the exchange engine 122 may grant requests for priority execution of an autonomous order and/or allocate hardware resources available in the computer environment to the autonomous order based on one or more configurable commission rules, such as rules defined by an operator of the digital exchange. Such configurable commission rules may include that an owner of the autonomous order has paid or has agreed to pay appropriate commissions for execution of the autonomous order. In example embodiment, amounts of such commissions may be calculated based on the level of priority and/or the hardware resources requested and/or other factors (e.g., as defined by an operator of the digital exchange).

To facilitate communication with other computing devices, a computing device includes a communication interface configured to receive a communication, such as a request, data, and the like, from another computing device in network communication with the computing device and pass the communication along to an appropriate module running on the computing device. The communication interface is also configured to send a communication to another computing device in network communication with the first computing device.

The electronic digital exchange 102 includes components and machines to provide programmatic APIs and/or web interfaces, respectively, to one or more software services, which may be hosted on a software-as-a-service (SaaS) layer or platform 104. The SaaS platform may be part of a service-oriented architecture, being stacked upon a platform-as-a-service (PaaS) layer 106, which may be, in turn, stacked upon an infrastructure-as-a-service (IaaS) layer 108 (e.g., in accordance with standards defined by the National Institute of Standards and Technology (NIST)).

The SaaS layer 104 includes an exchange engine 122, which can compile and execute uncompiled or pre-compiled computer code (e.g., that is received via the cloud 130 from one or more of the machines 110 and 116) so that one or more instructions to perform a trade of an asset may be determined and fulfilled. Orders can be stored as order book data 128 in database(s) 126 connected to the exchange engine 122 by database server(s) 124.

Further, while the system 100, shown in FIG. 1, employs a cloud-based architecture, various embodiments are, of course, not limited to such an architecture and could equally well find application in a client-server, distributed, or peer-to-peer system, for example. The exchange engine 122 could also be implemented as a stand-alone software program.

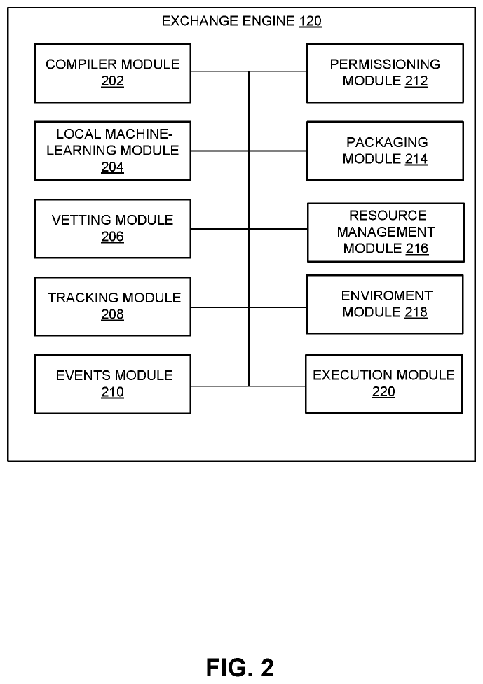

FIG. 2 is a block diagram depicting an example exchange engine 122 of FIG. 1. In example embodiments, a compiler module 202 is configured to compile code that is received from the client machine(s) 110, link the code to one or more internal and/or external libraries, and generate an executable program defining an autonomous order. The compiler module 202 may compile code in any computer language supported by the exchange engine 120, such as Python, Ocaml, Ruby, Go, Rust, and/or any other appropriate coding language. The compiler module 202 can receive code from the client machines 110 or broker machines 116, and at the exchange engine 122, compile the code for execution at the electronic digital exchange 102 and the various other modules described below. In some embodiments, the compiler module 202 can be configured to work with a runtime library or a virtual machine using threaded or multithreaded environments such as Green Threads or other similar thread implementations to automatically assign work to multiple processors. In some embodiments, the code is statically compiled; therefore, there is no code generation while the broker machines 116 or client machines 110 are running. This may provide an improved level of security for high risk trades.

The machine learning module 204 is configured to train and/or apply one or more machine-learning algorithms, such as a genetic algorithm, in real-time based on data accessible locally at the digital exchange, and/or access outputs from the machine learning algorithms 120 via the Broker API(s) 118 on the broker machine(s) 116), for use by one or more executing instances of one or more autonomous orders. The machine learning module 204 can be configured to cause a live evolution of the autonomous orders executing in the computer environment of the exchange engine 122 (e.g., through an application of a genetic algorithm). The machine learning module 204 can also be configured to provide optimal values for one or more variables upon which a tranding instruction defined by the autonomous order may be executed based on a timeframe of interest, such as a recent time frame or a time frame from the past.

The vetting module 206 is configured to vet the computer code compiled by the compiler module 202 on the exchange engine 122 (or pre-compiled at one or more client or broker machines). The vetting module 206 is further configured to determine the specific legal context for the orders depending on the legal requirements of the region where the trade takes place. The vetting module 206 programmability allows a taxonomy of autonomous order code using one or more predefined or configurable routines. The vetting module may determine whether the order was placed by a client on a client machine 110 or a broker on a broker machine 116 and if such submissions by a retail client or broker are approved.

The tracking module 208 is configured to track autonomous orders and corresponding trading instructions (e.g., as added to an order book) at the digital exchange. In some embodiments, the tracking module 208 can interact with the machine learning module 204 to send notification regarding the tracking at the electronic digital exchange 102 to the broker machines 116 and/or the client machines 110. The tracking module 208 may be queried by other modules within the exchange engine 122. The tracking module 208 can be configured to track the autonomous order hierarchy or tier level to facilitate prioritization of the autonomous orders by the exchange engine 122. The tracking module 208 can also track which of the orders in a family of orders is determined to be the “fittest” with respect to one or more metrics and, over time, facilitate evolution of the autonomous orders (e.g., via a genetic algorithm implemented by the execution module 220). In addition to sending notifications to external systems, the tracking module 208 can inform the other modules of the exchange engine 120 with respect to execution of instances of autonomous orders, such that the execution of future instances be made improved (e.g., with respect to speed, utilization of system resources, or other metrics, such as one or more performance metrics defined by an operator of the digital exchange).

The events module 210 is configured to register exchange events on the exchange engine 122. The event module allows for specific events that occur at the exchange engine 122 to trigger specific functions within the exchange engine 122 related to fulfilling orders within the order book. The event triggers can be used to generalize the type of order beyond the standard order types allowing for custom, hybrid, and/or exotic order types to be defined and filled by the exchange engine 122.

The permissioning module 212 is configured to determine the permissions of instances of an event or instances of an autonomous order in the electronic digital exchange 102. For example, the permissioning module can determine security permissions for instances of autonomous orders based on data associate with the autonomous order (e.g., order type), data related to identification of the autonomous order (e.g., permissions given to the autonomous order itself and/or an owner of the autonomous order), or data related to trade requirements (e.g., regional rules for the trade). In some embodiments, the permissioning module 212 may also be configured to hide particular orders from specific autonomous orders or owners and/or or set order status visibility for sets of autonomous orders, such as families of autonomous orders.

The packaging module 214 is configured to package autonomous orders such that functions within the package may be made accessible to other autonomous orders. The packaging module 214 can receive multiple autonomous orders and combine them into one or more packages (e.g., in order to dynamically group or cluster functions of the autonomous order that are related, share memory, or may be performed together). In example embodiments, a broker may supply one or more local functions as a package that are made accessible (e.g., via a dynamic linked library) to autonomous orders that are owned by a customer of the broker.

The resource management module 216 is configured to manage the resources on the electronic digital exchange 102 and/or in the exchange engine 122. The resource management module 216 can assign processing power, memory, or other computer resources to a particular instance of an autonomous order (e.g., based on a priority assigned to the instance of the autonomous order; or requests for computing resources included in the autonomous order itself or configurable computing resource allocation rules, such as computing resource allocation rules specified by an operator of the digital exchange).

The resource management module 216 can also be configured to dynamically request and/or return computing resources from/to any of the layers on which it depends, including, for example, the PaaS, IaaS, or SaaS layers, to ensure that only sufficient computing resources are available regardless of a volume of autonomous orders being submitted, compiled, linked, and/or executed increases and/or regardless of a volume of orders in the orderbook to, for example, ensure the performance of the digital exchange with respect to one or more performance metrics does not fall below one or more performance thresholds, such as performance thresholds related to speed of execution of orders in the order book, speed of compilation, linking or executing of instances of autonomous orders, and so on. The resource management module can also assign more computational resources to autonomous orders identified as higher-tiered by the tracking module 208.

The environment module 218 is configured to manage the computer environment of the digital exchange 120. The environment module 218 may provide one or more sub-environments for one or more client machines and/or one or more broker machines to interact with the electronic digital exchange, including for submitting autonomous orders for execution; assigning system resources, including platform, infrastructure, and software services; accessing local functions, and so on. In example embodiments, autonomous orders may be able to communicate across sub-environments and/or may have access to data that is accessible across sub-environments, such as the order book data 128.

The execution module 220 is configured to execute one or more instances of the compiled computer code for autonomous orders submitted to the exchange engine 122. Additionally, the execution module 220 is configured to execute other modules in the exchange engine 122, such as the events module 210, tracking module 208, permissioning module 212, or any other module included in the exchange engine 122.

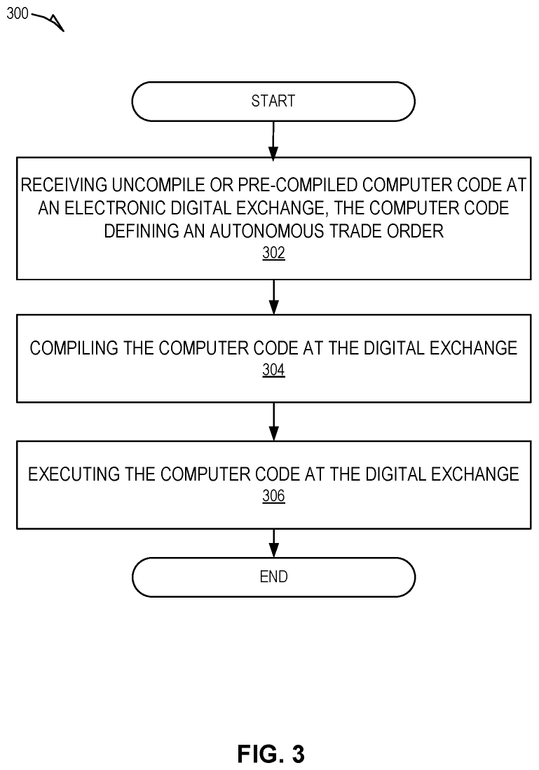

FIG. 3 is a flowchart of a method 300 for implementing autonomous orders at a digital exchange. While the various operations in this flowchart are presented and described sequentially, one of ordinary skill will appreciate that some or all of the operations may be executed in a different order, be combined or omitted, or be executed in parallel.

At operation 302, the exchange engine 122 receives uncompiled or pre-compiled computer code (e.g., via an API of an exchange engine 122), the computer code defining an autonomous order. The computer code may include one or more trading instructions that are to be executed based on one or more conditions being met (e.g., defined as variables in the computer code). These variables may relate to the trade itself (e.g., an amount of time the trade is to stay open, a number of assets to trade, a price associated with the trade (e.g., a sell price or a buy price), and so on) or any other data that is accessible at the digital exchange, including data pertaining to the order book of the digital exchange, instances of other autonomous orders executing at the digital exchange, and so on. In example embodiments, the pre-compiled computer code may specify that any of the variables may be set in real-time at the exchange engine based on application of one or more machine-learned algorithms. In example embodiments, the computer code may indicate that the autonomous order is to evolve in the computer environment of the digital exchange (e.g., through application of a genetic algorithm) such that it is optimized for one or more metrics specified by the autonomous order.

In example embodiments, if the computer code is pre-compiled at one or more client devices, it is run in a permissions-restricting sense at the exchange in order to not run something nefarious sent in from outside. In example embodiments, the one or more client devices send uncompiled source code to the exchange engine, which examines the computer code (e.g., through a vetting process) and performs the compiling and linking, thus giving an extra chance to prevent execution of misbehaving code. In example embodiments, whether dealing with pre-compiled or uncompiled computer code, the exchange engine may rely on the computer code being signed with allowed permissions, which essentially provides a tamper-proof seal.

At operation 304, the exchange engine 122 compiles uncompiled computer code and links the uncompiled computer code to libraries or packages made accessible to the computer code at the digital exchange and that contain functions called by executing instances of the autonomous order. The uncompiled code is compiled using computer resources available within a computer environment allocated for the instances of the autonomous orders that result from execution of the compiled computer code. In example embodiments, one or more trading orders are conditionally added to an order book based on a detection, in real time at the exchange engine, that one or more conditions specified by instances of the autonomous order have been satisfied. The variables that the trade is dependent upon can be efficiently and accurately determined by the exchange engine 122 because the values of the variables can be pulled by calling various runtime functions within the exchange engine 122 using system resources allocated specifically to the execution of the autonomous order.

In example embodiments, the digital exchange, by supporting autonomous orders, provides or allows for orders to be implemented that do not rely on constant limits, but rather on limits that are more generally related to values of functions computed while the order resides in and observes the digital exchange (e.g., in real-time). The digital exchange provides for safe evaluation of these functions (e.g., through vetting), which, in turn, allows the digital exchange to support synthetic liquidity, hybridized order types, and/or provide for other interesting consequences or opportunities that traders and brokers may foresee and/or exploit.

At operation 306, the exchange engine 122 executes the compiled computer code comprising the autonomous order. During their execution, the autonomous orders can send live reports and/or calculations to exchange-external interfaces in order to give an accurate account of the current status of the order. Furthermore, regulatory procedures can be automatically logged. When a new exchange event is processed by the exchange engine 122, the event can be registered by the events module 210 and consumed by the autonomous order, which can cause the autonomous orders to be added or removed from the order book of the digital exchange and/or be filled according to the trading instructions defined by the autonomous order.

In various example embodiments, a “fittest” version of an instance of the autonomous order is selected after a generation or cycle associated with the autonomous order and an “offspring” of the fittest version is used in a next generation or cycle. In various example embodiments, an initial population may be comprised of “genes” that correspond to metadata or attributes associated with the autonomous order, including values of variables, including threshold variables, specified in the uncompiled computer code associated with the autonomous order. These genes may be joined or encoded into a “chromosome” comprising a plurality of combinations or permutations of the genes. In various example embodiments, each candidate solution (also referred to as an individual, creature, or phenotype) may be represented as an array of bits or other type or as a similar data structure.

In various example embodiments, a fitness function determines how fit an individual is (e.g., the ability of the individual to compete with other individuals). In various example embodiments, the fitness function pertains to one or more of the performance metrics described herein. In various example embodiments, the probability that an individual will be selected for reproduction is based on its fitness score. In various example embodiments, each individual is of a fixed size (e.g., to facilitate crossover operations, as described below). In other embodiments, variable length representations and one or more tree-like representations, graph-form representations, or mix of both linear chromosomes and trees may be used. In various example embodiments, a fitness function value of an individual may be determined from simulations (e.g. in real time) with respect to the one or more performance metrics selected for the optimization.

In various example embodiments, one or more pairs of individuals (parents) are generated (e.g., randomly) or selected from a set of predetermined or randomly-generated individuals (e.g., based on fitness scores). In various example embodiments, the initial population may be seeded based on an assessment of where optimal solutions are likely to be found. For each pair of parents to be mated, a crossover (or recombination) point may be chosen (e.g., at random) from within the genes. Offspring are created by exchanging the genes of parents among themselves until the crossover point is reached. The new offspring are then added to the population (e.g., as a new generation).

In various example embodiments, in certain new offspring formed, some of their genes are subjected to mutation (e.g., with a lower random probability). Mutation may help to maintain diversity within the population and prevent premature convergence.

In various example embodiments, the fitness of each of the offspring of a generation are evaluated with the fitness function.

In various example embodiments, the algorithm terminates if the population has converged (e.g., it does not produce offspring that are significantly different from the previous generation), a configurable maximum number of generations has been produced, or a configurable satisfactory fitness level has been reached for the population.

In various example embodiments, the population may have a fixed size. As new generations are formed, individuals with least fitness die, providing space for new offspring.

In various example embodiments, the sequence is repeated with a goal to produce individuals in each new generation that are better than in the previous generation. For example, in example embodiments, one or more pairs of each successive generation are selected to breed a new generation, such as randomly or through a selection method that gives a higher weight to fitter solutions.

In example embodiments, the problem may be solved simultaneously using multiple different starting populations and optimal solutions identified from each starting point may be compared. If they do not converge, additional starting points may be used in an attempt to find a convergence. If no convergence is identified, a best solution from each of the convergences from each of the initial starting points may be selected as the optimal solution.

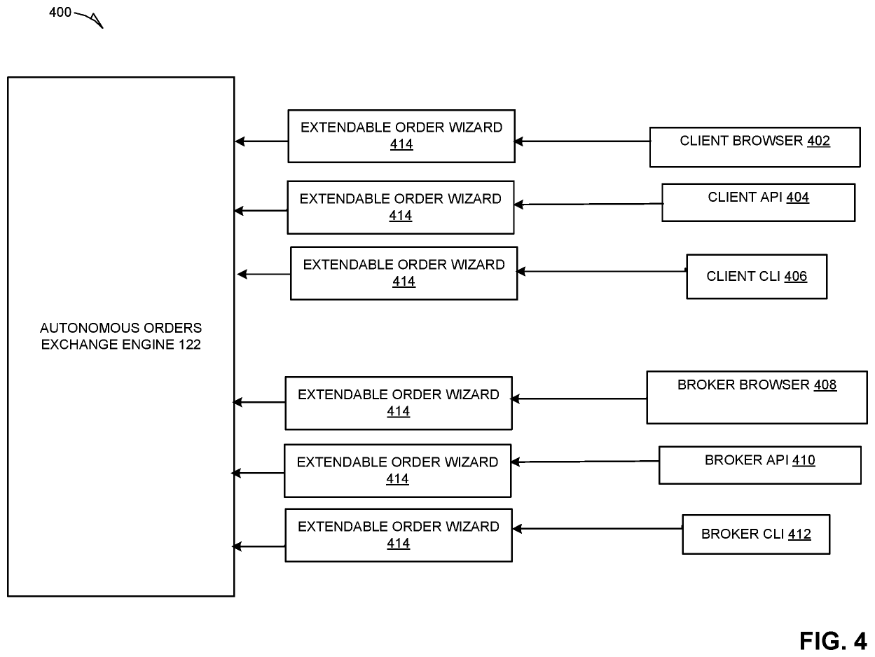

FIG. 4 is a block diagram depicting system interactions including an extendable order wizard 414. A client user (e.g., a trader) can define trading instructions as uncompiled or pre-compiled computer code for submission via a client browser 402, a client API 404, or a command line interface 406. A broker user can define trading instructions as uncompiled or pre-compiled computer code for submission via a broker browser 408, a broker API 410, and/or a broker command-line interface 412. The computer code can be sent over the cloud or by another communication method to the exchange order wizard 414. An instance of the exchange order wizard 414 can be created for each set of trading instructions sent.

The exchange order wizard 414 may be a cloud compiler with web, programmatic API, and/or command-line interface (CLI) access. The exchange order wizard 414 is configured to compile, vet, verify permissions, and/or package computer code defining autonomous orders that are received from an input source (e.g., brokers and/or individual traders) and forwards the compiled code to the autonomous exchange engine 122 to execute the compiled code. The exchange order wizard 414 can generate a containerized binary as part of the executable code it sends to the autonomous exchange engine 416.

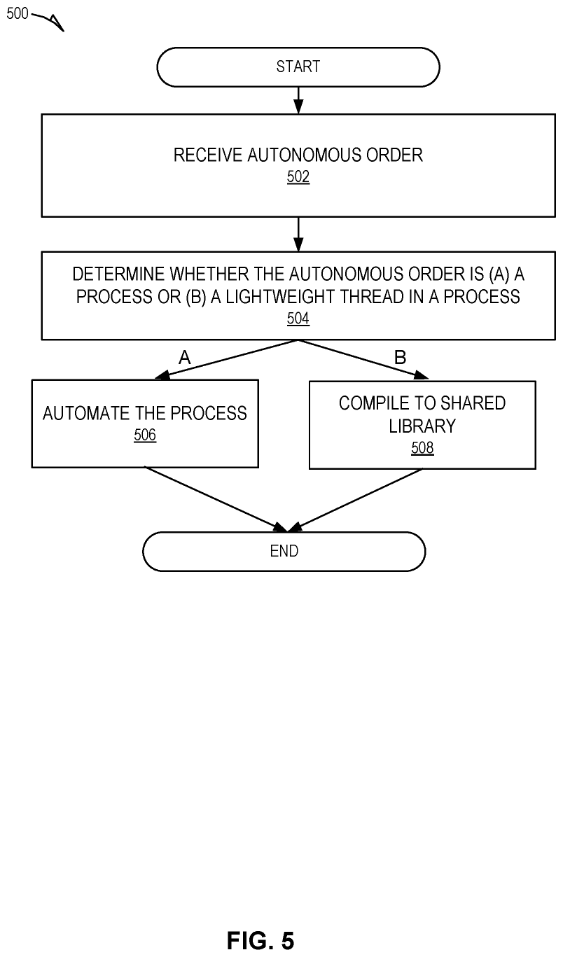

FIG. 5 is a flowchart of an example method 500 for executing an autonomous order at the digital exchange. While the various operations in this flowchart are presented and described sequentially, one of ordinary skill will appreciate that some or all of the operations may be executed in a different order, be combined or omitted, or be executed in parallel.

At operation 502, one or more autonomous orders are received (e.g., from one or more client machines and/or broker machines).

At operation 504, it is determined, for each of the one or more autonomous orders, if the autonomous order is either (A) a process or (B) a lightweight thread in a process.

At operation 506, based on a determination that the order is a process, the process is built and run (e.g., in a fully managed container-native service, such as AWS AppRunner or similar) to containerize the process and load balance the code for execution.

At operation 508, based on a determination that the order is a lightweight thread, the order is compiled into a shared library or shared object (e.g., a dynamic link library (DLL)) and made accessible to other autonomous orders (e.g., based on permissions) in real time.

For both operations 506 and 508, the autonomous order exchange wizard functionality is present either as an executable which loads and runs orders or as a library.

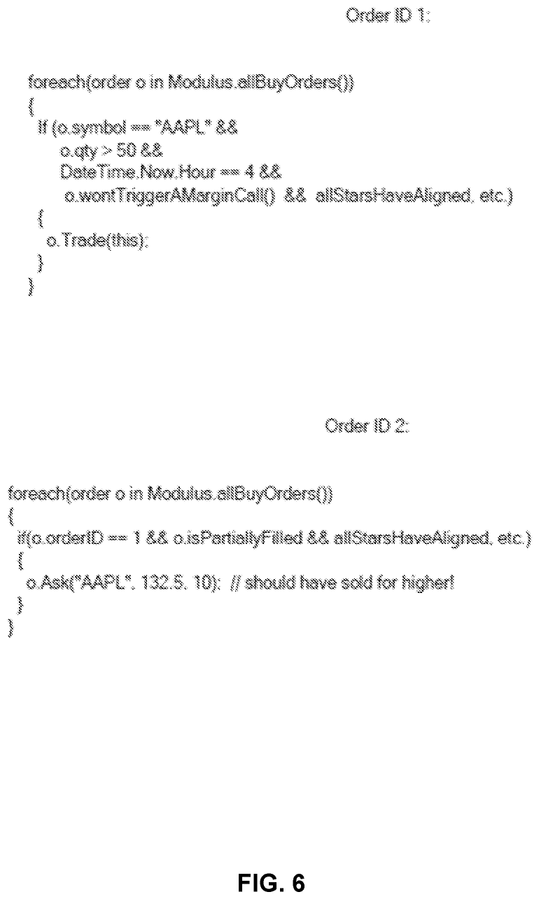

FIG. 6 shows examples of uncompiled code (e.g., for Order ID 1 and Order ID 2) that may be submitted for compiling, linking, and execution by the exchange engine.

As depicted in FIG. 6, the uncompiled code for Order ID 1 iterates over all of the buy orders in an order book for all assets at a digital exchange. If the symbol associated with the order is “AAPL,” the quantity associated with the order is greater than 50, the current time is 4, a margin call won't be triggered, and any other custom conditions have been met, the order requests execution of the buy order. In example embodiments, in response to the request for execution of the order, the digital exchange fulfills the order as a market order.

The uncompiled code for Order ID 2 iterates over all of the buy orders in the order book. Based on a determination that Order ID 1 has been partially filled (and any other custom conditions have been met), Order ID 2 requests that the order be modified to include an Ask price and a quantity. In example embodiments, in response to the addition of the Ask price and the quantity, the digital exchange modifies Order ID 1, changing it from a market order to a limit order with the specified ask price and quantity.

In example embodiments, the exchange engine 122 may be configured by one or more autonomous orders to fill a hybridized market limit order. In order to fulfill a hybridized market-limit order type, the exchange engine 122 can determine that two different order types, such as a limit order type and a market order, can be hybridized such that a match may occur between the two types. For example, if an order is configured to sell an asset at $3 and another order is set to buy the asset at $1, the exchange engine may generate an order that sets the price for the order to match the price, which might be $2 to facilitate the order in an autonomous fashion. This allows both parties to have completed a sale where, without the hybridized price for the order by the exchange engine 122, a fair middle ground would not be realized between the two order types. The exchange allows the two orders to gravitate towards one another according to their logic, and if both move at comparable rates, the exchange order book will evolve towards a match.

A further advantage of this technique is that, within the exchange engine 122, there may be a live evolution of incompatible orders to compatible orders that allows for liquidity of the orders and trades. This evolution creates synthetic liquidity that reduces the dependence on external liquidity pools outside the exchange engine 122.

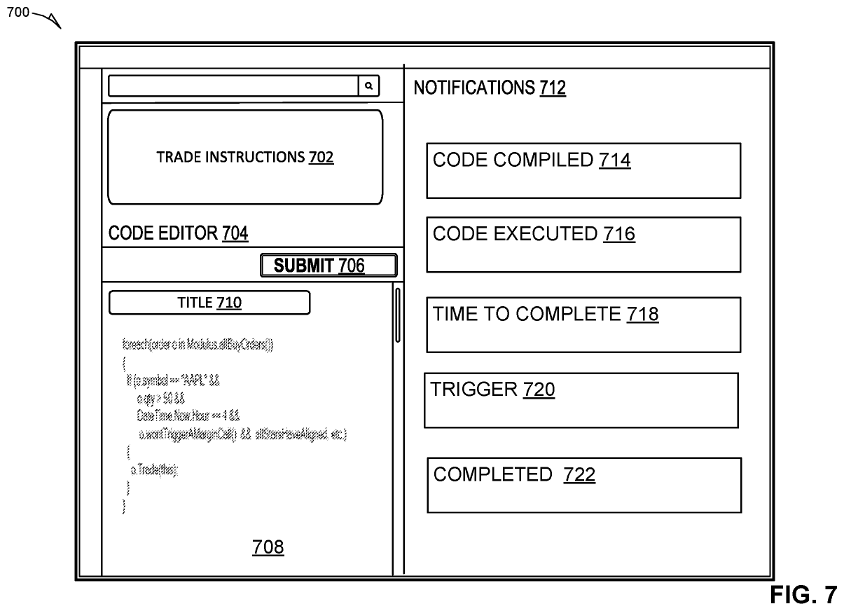

FIG. 7 is a screen shot of an example graphical user interface (GUI) (e.g., for presentation on a client or broker machine). In example embodiments, the GUI includes options for creating, editing, and/or debugging uncompiled or pre-compiled computer code for sending to the digital exchange and/or for presenting notifications related to execution of autonomous orders corresponding to the code at the digital exchange.

The UI 700 may include a first window 702 having a code editor 704, which allows for a user to input uncompiled computer code comprising one or trading instructions defining an autonomous order, and a user interface element (e.g., submit button 706) for submitting the code to the digital exchange for compiling, linking, and executing at the digital exchange. The UI 700 may also include a dashboard 708 for viewing, modifying, and/or debugging submitted code and/or metadata associated with the submitted code, such as a title of the submitted code. The UI 700 may include one or more windows for viewing and/or taking one or more actions with respect to notifications received from the digital exchange, such as notifications pertaining to execution of one or more autonomous orders at the digital exchange. Notifications received from the digital exchange may include any information described herein, such as whether submitted computer code has been compiled 714 or if the code has been executed 716. Other notifications, such as values of rigger variables 720 specified by the autonomous order and time remaining for completion of an order 718 can also be shown in the notifications window 712. A notification for the values of the variables when the order based on the code was completed 722 (or at other historical time points) can also be shown. While not shown, other information can be presented to the user in a graphical representation related to statistics of how long the code takes to compile and execute and how many orders have been completed.

In some embodiments, the user receives information about how the code has evolved and statistical information about how the evolved code is performing in order to fulfill the order request. The user can interact with UI 700 in order to select, pause, delete, and/or modify autonomous orders that are executing in the exchange engine 122.

FIG. 8 is a block diagram depicting an example mobile device, according to an example embodiment. The mobile device 800 can include a processor 802. The processor 802 can be any of a variety of different types of commercially available processors suitable for mobile devices 800. A memory 804, such as a random access memory (RAM), a Flash memory, or other type of memory, is typically accessible to the processor 802. The memory 804 can be adapted to store an operating system (OS) 806, as well as application programs 808, such as a mobile location-enabled application that can provide location-based services (LBSs) to a user. The processor 802 can be coupled, either directly or via appropriate intermediary hardware, to a display 810 and to one or more input/output (I/O) devices 812, such as a keypad, a touch panel sensor, a microphone, and the like. Similarly, in some embodiments, the processor 802 can be coupled to a transceiver 814 that interfaces with an antenna 816. The transceiver 814 can be configured to both transmit and receive cellular network signals, wireless data signals, or other types of signals via the antenna 816, depending on the nature of the mobile device 800. Further, in some configurations, a GPS receiver 818 can also make use of the antenna 816 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a stand-alone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

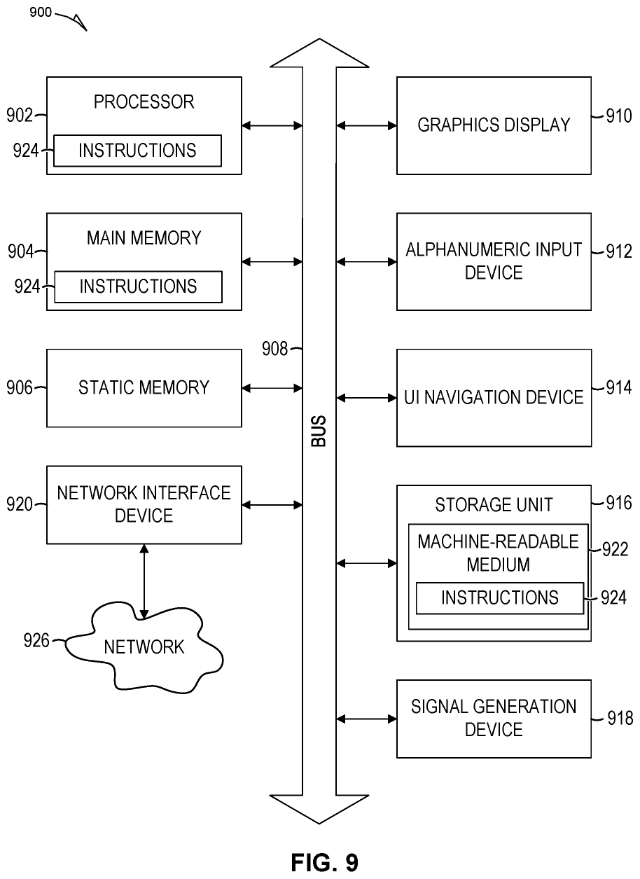

FIG. 9 is a block diagram of an example computer system 900 on which methodologies and operations described herein may be executed, in accordance with an example embodiment. In alternative embodiments, the machine operates as a stand-alone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a graphics display unit 910 (e.g., a liquid crystal display (LCD) or a cathode ray tube (CRT)). The computer system 900 also includes an alphanumeric input device 912 (e.g., a keyboard or a touch-sensitive display screen), a user interface (UI) navigation device 914 (e.g., a mouse), a storage unit 916, a signal generation device 918 (e.g., a speaker) and a network interface device 920.

### Machine-Readable Medium

The storage unit 916 includes a machine-readable medium 922 on which is stored one or more sets of instructions and data structures (e.g., software) 924 embodying or utilized by any one or more of the methodologies or functions described herein. The instructions 924 may also reside, completely or at least partially, within the main memory 904 and/or within the processor 902 during execution thereof by the computer system 900, the main memory 904 and the processor 902 also constituting machine-readable media.

While the machine-readable medium 922 is shown in an example embodiment to be a single medium, the term “machine-readable medium” may include a single medium or multiple media (e.g., a centralized or distributed database, and/or associated caches and servers) that store the one or more instructions 924 or data structures. The term “machine-readable medium” shall also be taken to include any tangible medium that is capable of storing, encoding or carrying instructions (e.g., instructions 924) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 924 may further be transmitted or received over a communications network 926 using a transmission medium. The instructions 924 may be transmitted using the network interface device 920 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show specific embodiments in which the subject matter may be practiced by way of illustration, not of limitation. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. Therefore, this Detailed Description is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

Components, or modules, shown in diagrams are illustrative of exemplary embodiments of the disclosure and are meant to avoid obscuring the disclosure. It shall also be understood that throughout this discussion, components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in software, hardware, or a combination thereof.

Furthermore, connections between components or systems within the figures are not intended to be limited to direct connections. Data between these components may be modified, re-formatted, or otherwise changed by intermediary components. Also, additional or fewer connections may be used. It shall also be noted that the terms “coupled,” “connected,” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

The use of certain terms in various places in the specification is for illustration and should not be construed as limiting. The terms “include,” “including,” “comprise,” and “comprising” shall be understood to be open terms, and any lists that follow are examples and not meant to be limited to the listed items.

A service, function, or resource is not limited to a single service, function, or resource; usage of these terms may refer to a grouping of related services, functions, or resources, which may be distributed or aggregated. The use of memory, database, information base, data store, tables, hardware, and the like may be used herein to refer to system component or components into which information may be entered or otherwise recorded. The terms such as “data” or “information,” along with similar terms, may be replaced by other terminologies referring to a group of bits, and may be used interchangeably. The terms “packet” or “frame” shall be understood to mean a group of bits. The term “frame” shall not be interpreted as limiting embodiments of the present invention to Layer 2 networks, and the term “packet” shall not be interpreted as limiting embodiments of the present invention to Layer 3 networks. The terms “packet,” “frame,” “data,” or “data traffic” may be replaced by other terminologies referring to a group of bits, such as “datagram” or “cell.” The words “optimal,” “optimize,” “optimization,” and the like refer to an improvement of an outcome or a process and do not require that the specified outcome or process has achieved an “optimal” or peak state.

It shall be noted that: (1) certain steps may optionally be performed; (2) steps may not be limited to the specific order set forth herein; (3) certain steps may be performed in different orders; and (4) certain steps may be done concurrently.

Any headings used herein are for organizational purposes only and shall not be used to limit the scope of the description or the claims. Each reference/document mentioned in this patent document is incorporated by reference herein in its entirety.

It shall be noted that any examples provided herein are provided by way of illustration and under specific conditions using a specific embodiment or embodiments; accordingly, neither these examples nor their implementations shall be used to limit the scope of the disclosure of the current patent document.

It shall also be noted that although embodiments described herein may be within the context of client-side enrichment and transform, aspects of the present disclosure are not so limited. Accordingly, the aspects of the present disclosure may be applied or adapted for use in other contexts.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims and the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in the context of specific illustrative configurations. Other allocations of functionality are envisioned and may fall within the scope of various embodiments of the present disclosure. In general, structures and functionality presented as separate resources in the example configurations may be implemented as a combined structure or resource.

Similarly, structures and functionality presented as a single resource may be implemented as separate resources. These and other variations, modifications, additions, and improvements fall within a scope of embodiments of the present disclosure as represented by the appended claims. Accordingly, the specification and drawings are to be regarded in an illustrative rather than a restrictive sense.

1. A method comprising:
receiving, via an API, computer code defining an autonomous trade order, the autonomous trade order including one or more pre-programmed trading instructions; and
compiling and executing the computer code within an exchange engine at an electronic digital exchange, the executing including instantiating the autonomous trade order and filling the autonomous trade order based on a determination that one or more conditions specified in the one or more pre-programmed trading instructions have been satisfied, the determination based on a detection that one or more events referenced from the pre-programmed trading instructions have occurred at the electronic digital exchange or an identification that one or more values of one or more variables referenced from the pre-programmed trading instructions have transgressed one or more values of one or more thresholds at the electronic digital exchange.

2. The method of claim 1, wherein the identification that the one or more values of the one or more variables referenced from the pre-programmed trading instructions have transgressed one or more values of one or more thresholds at the electronic digital exchange includes invoking an API that is made accessible to the computer code at the electronic digital exchange.

3. The method of claim 2, wherein the API returns an output from a machine-learning algorithm that is live-trained at the electronic digital exchange.

4. The method of claim 1, wherein the detection that the one or more events referenced from the pre-programmed trading instructions have occurred is based on handler for the one or more events being invoked by the exchange engine, the handler being registered by the instantiated autonomous trade order.

5. The method of claim 4, wherein the one or more events include at least one of a match, an arrival, or a partial fill corresponding to the autonomous order.

6. The method of claim 1, wherein the autonomous trade order is included an orderbook of autonomous trade orders maintained by the exchange engine at the electronic digital exchange and wherein the one or more values of the one or more variables relates to one or more additional autonomous trade orders included in the orderbook of autonomous trade orders.

7. The method of claim 1, wherein computing resources are allocated by the exchange engine at the digital exchange based on requests for the computing resources included in the computer code.

8. A system comprising:
one or more computer memories;
one or more computer processors; and
a set of instructions incorporated into the one or more computer memories, the set of instructions configuring the one or more computer processors to perform operations, the operations comprising:
receiving, via an API, computer code defining an autonomous trade order, the autonomous trade order including one or more pre-programmed trading instructions; and
compiling and executing the computer code within an exchange engine at an electronic digital exchange, the executing including instantiating the autonomous trade order and filling the autonomous trade order based on a determination that one or more conditions specified in the one or more pre-programmed trading instructions have been satisfied, the determination based on a detection that one or more events referenced from the pre-programmed trading instructions have occurred at the electronic digital exchange or an identification that one or more values of one or more variables referenced from the pre-programmed trading instructions have transgressed one or more values of one or more thresholds at the electronic digital exchange.

9. The system of claim 8, wherein the identification that the one or more values of the one or more variables referenced from the pre-programmed trading instructions have transgressed one or more values of one or more thresholds at the electronic digital exchange includes invoking an API that is made accessible to the computer code at the electronic digital exchange.

10. The system of claim 9, wherein the API returns an output from a machine-learning algorithm that is live-trained at the electronic digital exchange.

11. The system of claim 8, wherein the detection that the one or more events referenced from the pre-programmed trading instructions have occurred is based on handler for the one or more events being invoked by the exchange engine, the handler being registered by the instantiated autonomous trade order.

12. The system of claim 11, wherein the one or more events include at least one of a match, an arrival, or a partial fill corresponding to the autonomous order.

13. The system of claim 8, wherein the autonomous trade order is included an orderbook of autonomous trade orders maintained by the exchange engine at the electronic digital exchange and wherein the one or more values of the one or more variables relates to one or more additional autonomous trade orders included in the orderbook of autonomous trade orders.

14. The system of claim 8, wherein computing resources are allocated by the exchange engine at the digital exchange based on requests for the computing resources included in the computer code.

15. A non-transitory computer-readable storage medium storing a set of instructions that, when executed by one or more computer processors, causes the one or more computer processors to perform operations, the operations comprising:
receiving, via an API, computer code defining an autonomous trade order, the autonomous trade order including one or more pre-programmed trading instructions; and
compiling and executing the computer code within an exchange engine at an electronic digital exchange, the executing including instantiating the autonomous trade order and filling the autonomous trade order based on a determination that one or more conditions specified in the one or more pre-programmed trading instructions have been satisfied, the determination based on a detection that one or more events referenced from the pre-programmed trading instructions have occurred at the electronic digital exchange or an identification that one or more values of one or more variables referenced from the pre-programmed trading instructions have transgressed one or more values of one or more thresholds at the electronic digital exchange.

16. The non-transitory computer-readable storage medium of claim 15, wherein the identification that the one or more values of the one or more variables referenced from the pre-programmed trading instructions have transgressed one or more values of one or more thresholds at the electronic digital exchange includes invoking an API that is made accessible to the computer code at the electronic digital exchange.

17. The non-transitory computer-readable storage medium of claim 16, wherein the API returns an output from a machine-learning algorithm that is live-trained at the electronic digital exchange.

18. The non-transitory computer-readable storage medium of claim 15, wherein the detection that the one or more events referenced from the pre-programmed trading instructions have occurred is based on handler for the one or more events being invoked by the exchange engine, the handler being registered by the instantiated autonomous trade order.

19. The non-transitory computer-readable storage medium of claim 15, wherein computing resources are allocated by the exchange engine at the digital exchange based on requests for the computing resources included in the computer code.

20. The non-transitory computer-readable storage medium of claim 15, wherein the autonomous trade order is included an orderbook of autonomous trade orders maintained by the exchange engine at the electronic digital exchange and wherein the one or more values of the one or more variables relates to one or more additional autonomous trade orders included in the orderbook of autonomous trade orders.
